(19) United States
(12) Patent Application Publication
(10) Pub. No.: US 2026/0148278 A1
(43) Pub. Date: May 28, 2026

(54) INTELLIGENT PRODUCT RECOMMENDATION SYSTEM

(71) Applicant: SAP SE, Walldorf (DE)

(72) Inventors: Wanchen Zhao, North York (CA); Venkata Narasimha Rao Sandu, Singapore (SG); Yu Xuan Lee, Singapore (SG)

(73) Assignee: SAP SE, Walldorf (DE)

(21) Appl. No.: 18/957,334

(22) Filed: Nov. 22, 2024

(51) Int. Cl. G06Q 30/0601; G06F 16/33; G06F 16/383

(52) U.S. Cl. CPC G06Q 30/0631; G06F 16/3347; G06F 16/383

(57) ABSTRACT

A computer-implemented method includes receiving a query describing challenges encountered by a user from a user interface, obtaining one or more text segments that are semantically related to the query, composing prompt using a prompt template which includes a placeholder for receiving the one or more text segments, prompting a generative artificial intelligence model using the prompt to determine a ranked list of documents containing solutions to address the challenges, and presenting a response generated by the generative artificial intelligence model on the user interface. Related systems and software for implementing the method are also disclosed.

### BACKGROUND

Enterprise Resource Planning (ERP) systems are comprehensive software solutions that manage and integrate a company's financials, supply chain, operations, reporting, manufacturing, and human resource activities. Within this framework, product recommendation software can be tailored for business-to-business (B2B) transactions. Unlike business-to-consumer (B2C) product recommendation, which caters to a broader user environment with shorter cycles, the B2B product recommendation targets a narrower user base, involve longer lead times, and require more precise user segmentation. The smaller pool of users demands highly tailored services. Traditionally, this customization has been achieved manually, requiring the analysis of large volumes of client-specific data, such as news, reports, and financial documents. This manual research is not only labor-intensive and time-consuming but also prone to errors. Thus, room for improvements exists for enhancing the efficiency and accuracy of the product recommendation process within ERP systems.

### BRIEF DESCRIPTION OF THE DRAWINGS

FIG. 1 is an overall block diagram of an example EPR system supporting intelligent product recommendation.

FIG. 2 is a flowchart illustrating an example overall method for intelligent product recommendation.

FIG. 3 is an architecture diagram of an example large language model.

FIG. 4 is a sequence diagram illustrating example operations involved in creating a vector database.

FIG. 5 depicts example text fields extracted from source documents.

FIG. 6 is a sequence diagram illustrating example operations involved for generating intelligent product recommendations.

FIG. 7 depicts an example use case of intelligent product recommendation.

FIG. 8 depicts an example user interface for intelligent product recommendation.

FIG. 9 is a block diagram of an example computing system in which described embodiments can be implemented.

FIG. 10 is a block diagram of an example cloud computing environment that can be used in conjunction with the technologies described herein.

### DETAILED DESCRIPTION

### Overview of Product Recommendation Techniques

ERP is an integrated software solution that allows an organization to use a system of integrated applications to manage their business and automate many back-office functions related to technology, services and human resources. An example ERP application is product recommendation for B2B environments.

In B2B product recommendation, traditional approaches have relied on structured pipelines that process large datasets to uncover patterns in customer behavior. These methods often utilize natural language processing (NLP) to capture customer needs and incorporate supervised machine learning models trained on historical sales data to generate product recommendations for future clients. An important aspect of this process is the extraction of information from diverse sources such as news articles and firmographic data, which is then transformed into categorical features to guide the recommendation models. However, despite the technical sophistication of these systems, they face several challenges that limit their effectiveness in real-world applications.

One major technical challenge is the availability and sufficiency of training data. B2B product portfolios often contain thousands of products at granular levels, yet many products have limited purchase records. This results in an imbalanced and insufficient dataset for supervised learning, where the model's accuracy can be undermined by the lack of representative data. The scarcity of transaction records, especially for niche products, hampers the model's ability to make reliable predictions.

Another technical challenge arises from the way sales records are stored and maintained. In many cases, important data such as historical transactions and customer details may be kept in different formats (e.g., spreadsheets, WORD documents, XML files, etc.). The diverse data formats can complicate the automated data ingestion process, which is important for systems that require frequent model retraining. Without an automated mechanism for regularly updating the dataset, models can become obsolete and may recommend outdated products, reducing the system's relevance in evolving conditions.

Furthermore, the use of rule-based techniques for text processing presents additional limitations. While rule-based NLP methods can handle structured text inputs, they struggle with understanding complex or non-standard grammatical structures, leading to incomplete or inaccurate data extraction. This can lead to information loss, where key insights are missed during the conversion of unstructured text into actionable data. Moreover, the supervised machine learning models are unable to address the classic “cold start” problem, meaning that the pipelines of these traditional approaches may not be applicable to new customers.

The technologies described herein address the above challenges by implementing an intelligent product recommender system that leverages generative artificial intelligence (AI), which can effectively match customers'challenges with appropriate solutions.

### Example Overall Computing System for Intelligent Product Recommendation

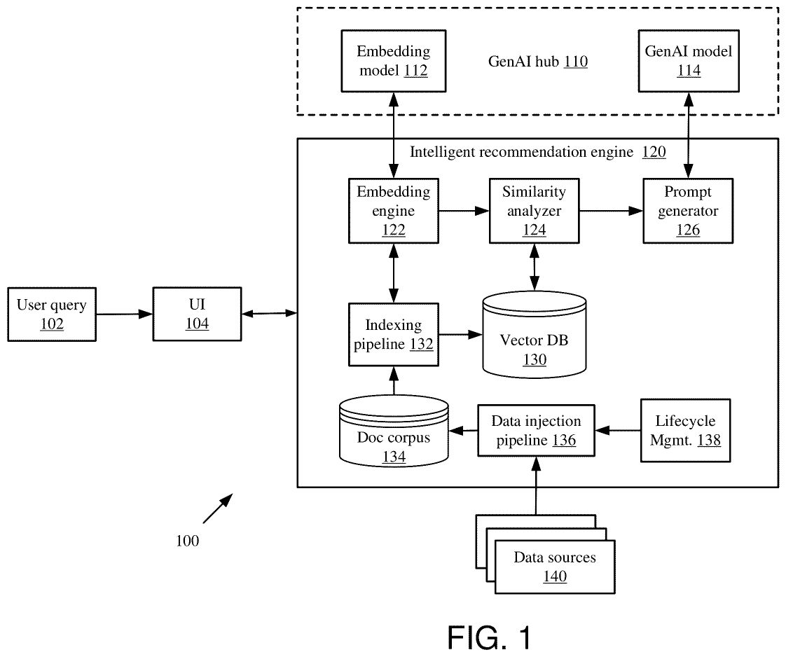

FIG. 1 shows an overall block diagram of an example ERP system 100 configured for intelligent product recommendation, for example, in a B2B environment.

The ERP system 100 includes an intelligent recommendation engine 120 in communication with a generative AI hub 110.

The generative AI hub 110 can be used to provide generative AI (“GenAI”) capabilities to the intelligent recommendation engine 120. In some examples, the generative AI hub 110 can be hosted externally (e.g., on a third-party platform). In other examples, the generative AI hub 110 can be deployed locally on the ERP system 100. The generative AI hub 110 can include an embedding model 112 and a generative AI model 114. The embedding model 112 is configured to transform input text into a dense vector representation that captures semantic meaning of the input text. In some examples, the embedding model 112 can be text-embedding-ada-002 provided by OpenAI. In other examples, the embedding model 112 can be others, such as Bidirectional Encoder Representations from Transformers (BERT), FastText, Word2Vec, GloVe, or the like. The generative AI model 114 is configured to generate natural language text or responses based on input prompts. Example generative AI model 114 can be Generative Pre-trained Transformer (GPT) or BERT-based models, or the like. Although in the depicted examples the embedding model 112 and the generative AI model 114 are shown as two different units, in other examples, the embedding model can be a component of the generative AI model.

The intelligent recommendation engine 120 can be configured to create and maintain a vector database 130 during a design phase. During a runtime phase, an end user can input a user query 102 through a user interface 104 (UI). The user query 102 can be expressed in natural language and contain descriptions of specific challenges faced by the end user. In response to the user query 102, the intelligent recommendation engine 120 can be configured to provide intelligent product recommendations that can address those challenges.

The intelligent recommendation engine 120 can include an embedding engine 122, a similarity analyzer 124, and a prompt generator 126. The embedding engine 122 can utilize the embedding model 112 to map words, sentences, or a text segment to a multi-dimensional vector of real numbers. Consequently, the embedding engine 122 can convert the user query 102 into a vector embedding (also referred to as “input vector embedding), which captures semantic and syntactic relationships among the words in the user query 102.

The similarity analyzer 124 can be configured to search the vector database 130, which stores a plurality of vector embeddings corresponding to respective text segments. The searching can identify, among the plurality of vector embeddings, one or more target vector embeddings that match the input vector embedding. Specifically, the similarity analyzer 124 can be configured to measure similarities between the input vector embedding and the plurality of vector embeddings stored in the vector database 130. An example similarity measurement can be cosine similarity, which quantifies the cosine of the angle between two vectors. A high cosine similarity indicates a smaller angle and hence a higher degree of semantic similarity between text represented by the two vectors. The similarity analyzer 124 can be configured to rank the vector embeddings stored in the vector database 130 based on their cosine similarity scores relative to the input vector embedding. The one or more target vector embeddings can be identified as those with the highest cosine similarity scores (e.g., top N, where N is a predefined integer), indicating they represent the closest match in terms of semantic content.

The prompt generator 126 can be configured to automatically generate a prompt based on a prompt template and submit this prompt to the generative AI model 114. In response, the generative AI model 114 can generate a reply, which can be formatted by the intelligent recommendation engine 120 and presented as an answer on the user interface 104.

The prompt template can include specific instructions for the generative AI model 114 to find relevant products that can address the challenges described in the user query 102. The prompt template can include one or more placeholders which can be populated with relevant text. For example, one placeholder can be filled with the received user query 102. Another placeholder can be populated with relevant text segments corresponding to the one or more target vector embeddings, which can be retrieved from vector database 130. In a non-limiting example, HumanMessage and SystemMessage templates provided by Langchain can used to generate the prompt.

Including the relevant text segments and the user query in the prompt provides the generative AI model 114 with contextual information that enhance its understanding of the user's needs and challenges as well as pertinent knowledge within the relevant domain of expertise, thereby improving the accuracy and relevance of the generated response. In other words, by incorporating such contextual information, the generative AI model 114 can tailor its reply to the specific context of the user query, leading to more meaningful and actionable recommendations.

In some examples, one or more target documents can be identified. These target documents contain relevant text segments associated with the target vector embeddings (e.g., the ones with the highest similarity score determined by the similarity analyzer 124). In some examples, a target document can include multiple relevant text segments. For example, a target document can be a Value Advisory for a specific software solution, comprising several relevant text segments that describe customer pain points, the value proposition of the solution, and other pertinent information, respectively.

The target documents can be stored in a document corpus 134 (which can also be referred to as a data lake), which represents a comprehensive repository of various types of documents related to all products managed by the ERP system 100, such as Value Advisory documents, sales planning documents, market analysis documents, sales records, business intelligence documents, and other materials. To create the document corpus 134, a data injection pipeline 136 can be used to retrieve relevant documents from a variety of data sources 140.

As noted above, the vector database 130 can be created in the design phase and maintained by the intelligent recommendation engine 120. For example, the intelligent recommendation engine 120 can include an indexing pipeline 132 which is configured to generate the plurality of vector embeddings stored in the vector database 130 based on documents contained in the document corpus 134.

In some examples, the indexing pipeline 132 can divide each document into smaller text segments, which can be defined by a predetermined length of text (e.g., number of tokens). In some examples, a predefined overlap between adjacent text segments can be introduced to ensure continuity of context across text segments. This segmentation approach can be applied uniformly across different document types, including spreadsheets, PDFs, Word documents, XML files, or the like. Each document type can be parsed according to its structure. For example, spreadsheets can be segmented by rows or cell ranges, PDFs and Word documents by paragraphs or sections, and XML files by specific nodes or tags, etc. The segmentation process ensures that even complex or lengthy documents are broken down into manageable pieces, facilitating accurate embedding and retrieval.

After the documents are segmented, each text segment can be processed by the embedding engine 122 (utilizing the embedding model 112) to generate a vector embedding which captures the semantic meaning of the text segment. The generated vector embeddings are then stored in the vector database 130. In addition to the vector embeddings, the corresponding text segments and relevant metadata can also be indexed alongside the embeddings in the vector database 130. During runtime, the vector database 130 can be used for efficient retrieval and matching, enabling the intelligent recommendation engine 120 to quickly identify and utilize relevant context information (e.g., based on vector similarity) for prompting the generative AI model 114.

In some examples, the intelligent recommendation engine 120 can further include a lifecycle management unit 138 which is configured to ensure that the vector database 130 is kept up to date with the most current information. An administrator can configure the lifecycle management unit 138 to monitor changes in the data sources 140, ensuring that important updates to the documents can be timely reflected in the document corpus 134, which in turn affects the content of the vector database 130. Additional details of the lifecycle management unit 138 and its operations are described further below.

In practice, the systems shown herein, such as the ERP system 100, can vary in complexity, with additional functionality, more complex components, and the like. For example, there can be additional functionality within the intelligent recommendation engine 120. Additional components can be included to implement security, redundancy, load balancing, report design, data logging, and the like.

The described computing systems can be networked via wired or wireless network connections, including the Internet. Alternatively, systems can be connected through an intranet connection (e.g., in a corporate environment, government environment, or the like).

The ERP system 100 and any of the other systems described herein can be implemented in conjunction with any of the hardware components described herein, such as the computing systems described below (e.g., processing units, memory, and the like). In any of the examples herein, user queries, vector embeddings, prompts, text segments, and the like can be stored in one or more computer-readable storage media or computer-readable storage devices. The technologies described herein can be generic to the specifics of operating systems or hardware and can be applied in any variety of environments to take advantage of the described features.

### Example Lifecycle Management

In some examples, the lifecycle management unit 138 can be configured by the administrator to periodically check the data sources 140 for any changes. For example, the lifecycle management unit 138 can be set to perform these checks every day or at another regular interval. During these checks, the lifecycle management unit 138 evaluates whether there have been any additions, deletions, or modifications to the documents stored in the data sources 140. If changes are detected, the lifecycle management unit 138 then controls the data injection pipeline 136 to retrieve the updated documents from the data sources 140 and update the document corpus 134 accordingly.

Alternatively, the lifecycle management unit 138 can be configured to operate the data injection pipeline 136 on demand, triggering document retrieval only when changes occur in the data sources 140. In this configuration, addition of a new document, deletion of an existing document, or modification to a newer version of an existing document in the data sources 140 can automatically trigger the lifecycle management unit 138 to activate the data injection pipeline 136 for document retrieval.

Any update to the document corpus 134 can cause corresponding update of the vector database 130. For example, if a new document is added to the document corpus 134, the indexing pipeline 132 will divide it into text segments, each of which will be converted into a corresponding vector embedding which is then saved in the vector database 130, along with the corresponding text segment. Similarly, when an outdated document is deleted from the document corpus 134, the associated text segments and their corresponding vector embeddings will be removed from the vector database 130. In cases where an existing document in the document corpus 134 is modified or replaced with a new version, the document will be re-segmented, and each updated text segment will be re-converted into new vector embeddings, which will replace the old vector embeddings in the vector database 130, and the corresponding text segments will be refreshed as well.

Thus, the lifecycle management unit 138 ensures that the vector database 130 consistently reflect the most current and accurate information. This ongoing maintenance enables the intelligent recommendation engine 120 to reliably retrieve and utilize relevant data, thereby enhancing its effectiveness in generating recommendations in response to the user queries.

### Example Overall Method for Improving Test Data Troubleshooting in ERP Systems

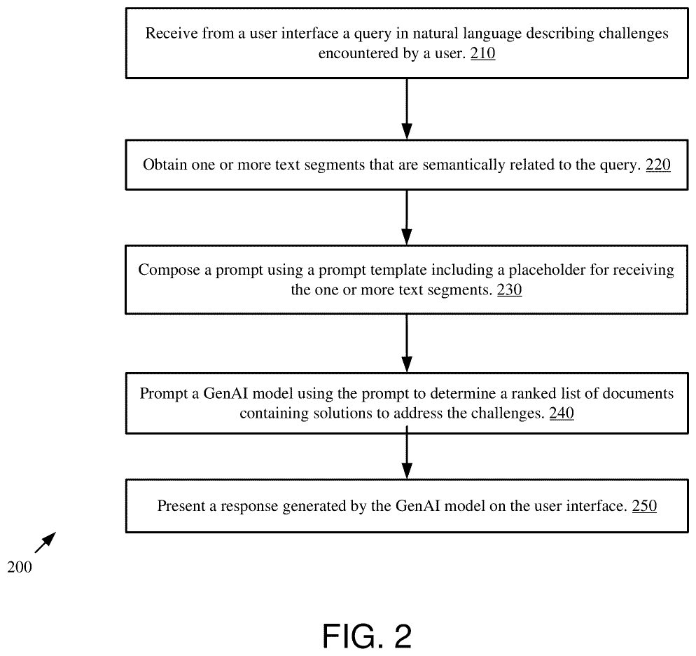

FIG. 2 is a flowchart illustrating an example overall method 200 for intelligent product recommendation in ERP systems. The method 200 can be performed, e.g., by the intelligent recommendation engine 120 of FIG. 1.

At step 210, the method can receive, from a user interface, a query in natural language describing challenges encountered by a user.

At step 220, the method can obtain, in runtime, one or more text segments that are semantically related to the query.

In some examples, the operation of obtaining one or more text segments semantically related to the query includes converting the query into an input vector embedding, measuring similarities between the input vector embedding and a plurality of vector embeddings stored in a vector database, and ranking the similarities and identifying top N vector embeddings that are associated with highest similarities, wherein N is a predefined positive integer.

In some examples, the method can further include creating the vector database based on a set of documents collected from a plurality of data sources.

In some examples, the operation of creating the vector database includes cleaning the set of documents. The cleaning can be configured to remove duplicates and special characters from the set of documents and organize remaining text in the set of documents in respective text fields.

In some examples, the operation of creating the vector data includes dividing the set of documents into a plurality of text segments, converting the plurality of text segments into respective vector embeddings, and indexing the plurality of text segments and the respective vector embeddings in the vector database.

In some examples, the method can periodically update the vector database, including scanning the plurality of data sources to detect whether there is an update to the set of documents.

At step 230, the method can compose, in runtime, a prompt using a prompt template. The prompt template includes at least one placeholder for receiving the one or more text segments.

At step 240, the method can prompt, in runtime, a generative AI model using the prompt to determine a ranked list of documents containing solutions to address the challenges.

Then, at step 250, the method can present a response generated by the generative AI model on the user interface.

In some examples, the method can further retrieve reference sources based on the response generated by the generative AI model and present the reference sources on the user interface.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “send” can also be described as “receive” from a different perspective.

### Example Overview of Generative AI and Prompts

Generative AI models, foundation models, and large language models (LLMs) are interconnected concepts in the field of AI. Generative AI, a broad term, encompasses AI systems that generate content such as text, images, music, or code. Unlike discriminative AI models that aim to make decisions or predictions based on input data features, generative AI models focus on creating new data points. Foundation models are a subset of these generative AI models, serving as a starting point for developing more specialized models. LLMs, a specific type of generative AI, work with language and can understand and generate human-like text. In the context of generative AI, including LLMs, a prompt serves as an input or instruction that informs the AI of the desired content, context, or task. This allows users to guide the AI to produce tailored responses, explanations, or creative content based on the provided prompt.

In any of the examples herein, an LLM can take the form of an AI model that is designed to understand and generate human language. Such models typically leverage deep learning techniques such as transformer-based architectures to process language with a very large number (e.g., billions) of parameters. Examples include the Generative Pre-trained Transformer (GPT) developed by OpenAI, Bidirectional Encoder Representations from Transforms (BERT) by Google, A Robustly Optimized BERT Pretraining Approach developed by Facebook AI, Megatron-LM of NVIDIA, or the like. Pretrained models are available from a variety of sources.

In any of the examples herein, prompts can be provided, in runtime, to LLMs to generate responses. Prompts in LLMs can be input instructions that guide model behavior. Prompts can be textual cues, questions, or statements that users provide to elicit desired responses from the LLMs. Prompts can act as primers for the model's generative process. Sources of prompts can include user-generated queries, predefined templates, or system-generated suggestions. Technically, prompts are tokenized and embedded into the model's input sequence, serving as conditioning signals for subsequent text generation. Experiment with prompt variations can be performed to manipulate output, using techniques like prefixing, temperature control, top-K sampling, chain-of-thought, etc. These prompts, sourced from diverse inputs and tailored strategies, enable users to influence LLM-generated content by shaping the underlying context and guiding the neural network's language generation. For example, prompts can include instructions and/or examples to encourage the LLMs to provide results in a desired style and/or format.

### Example Architecture of LLM

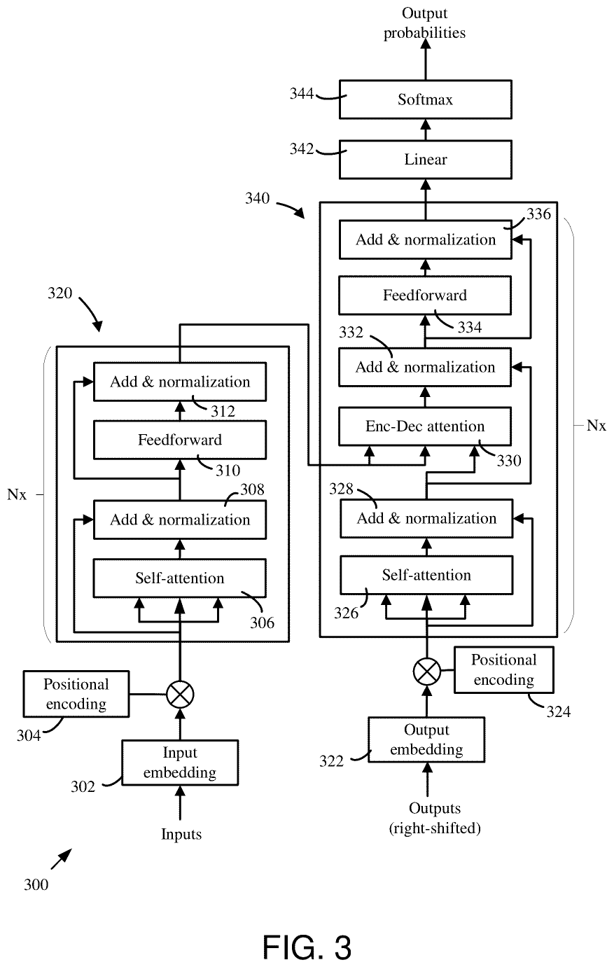

FIG. 3 shows an example architecture of an LLM 300, which can be used as the generative AI model 114 of FIG. 1.

In the depicted example, the LLM 300 uses an autoregressive model (as implemented in OpenAI's GPT) to generate text content by predicting the next word in a sequence given the previous words. The LLM 300 can be trained to maximize the likelihood of each word in the training dataset, given its context.

As shown in FIG. 3, the LLM 300 can have an encoder 320 and a decoder 340, the combination of which can be referred to as a “transformer.” The encoder 320 processes input text, transforming it into a context-rich representation. The decoder 340 takes this representation and generates text output.

For autoregressive text generation, the LLM 300 generates text in order, and for each word it generates, it relies on the preceding words for context. During training, the target or output sequence, which the model is learning to generate, is presented to the decoder 340. However, the output is right shifted by one position compared to what the decoder 340 has generated so far. In other words, the model sees the context of the previous words and is tasked with predicting the next word. As a result, the LLM 300 can learn to generate text in a left-to-right manner, which is how language is typically constructed.

Text inputs to the encoder 320 can be preprocessed through an input embedding unit 302. Specifically, the input embedding unit 302 can tokenize a text input into a sequence of tokens, each of which represents a word or part of a word. Each token can then be mapped to a fixed-length vector known as an input embedding, which provides a continuous representation that captures the meaning and context of the text input. Likewise, to train the LLM 300, the targets or output sequences presented to the decoder 340 can be preprocessed through an output embedding unit 322. Like the input embedding unit 302, the output embedding unit 322 can provide a continuous representation, or output embedding, for each token in the output sequences.

Generally, the vocabulary in LLM 300 is fixed and is derived from the training data. The vocabulary in LLM 300 consists of tokens generated above during the training process. Words not in the vocabulary cannot be output. These tokens are strung together to form sentences in the text output.

In some examples, positional encodings (e.g., 304 and 324) can be performed to provide sequential order information of tokens generated by the input embedding unit 302 and output embedding unit 322, respectively. Positional encoding is needed because the transformer, unlike recurrent neural networks, process all tokens in parallel and do not inherently capture the order of tokens. Without positional encoding, the model would treat a sentence as a collection of words, losing the context provided by the order of words. Positional encoding can be performed by mapping each position/index in a sequence to a unique vector, which is then added to the corresponding vector of input embedding or output embedding. By adding positional encoding to the input embedding, the model can understand the relative positions of words in a sentence. Similarly, by adding positional encoding to the output encoding, the model can maintain the order of words when generating text output.

Each of the encoder 320 and decoder 340 can include multiple stacked or repeated layers (denoted by Nx in FIG. 3). The number of stacked layers in the encoder 320 and/or decoder 340 can vary depending on the specific LLM architecture. Generally, a higher “N” typically means a deeper model, which can capture more complex patterns and dependencies in the data but may require more computational resources for training and inference. In some examples, the number of stacked layers in the encoder 320 can be the same as the number of stacked layers in the decoder 340. In other examples, the LLM 300 can be configured so that the encoder 320 and decoder 340 can have different numbers of layers. For example, a deeper encoder (more layers) can be used to better capture the input text's complexities while a shallower decoder (fewer layers) can be used if the output generation task is less complex).

The encoder 320 and the decoder 340 are related through shared embeddings and attention mechanisms, which allow the decoder 340 to access the contextual information generated by the encoder 320, enabling the LLM 300 to generate coherent and contextually accurate responses. In other words, the output of the encoder 320 can serve as a foundation upon which the decoder network can build the generated text.

Both the encoder 320 and decoder 340 comprise multiple layers of attention and feedforward neural networks. An attention neural network can implement an “attention” mechanism by calculating the relevance or importance of different words or tokens within an input sequence to a given word or token in an output sequence, enabling the model to focus on contextually relevant information while generating text. In other words, the attention neural network plays “attention” on certain parts of a sentence that are most relevant to the task of generating text output. A feedforward neural network can process and transform the information captured by the attention mechanism, applying non-linear transformations to the contextual embeddings of tokens, enabling the model to learn complex relationships in the data and generate more contextually accurate and expressive text.

In the example depicted in FIG. 3, the encoder 320 includes an intra-attention or self-attention neural network 306 and a feedforward neural network 310, and the decoder 340 includes a self-attention neural network 326 and a feedforward neural network 334. The self-attention neural networks 306, 326 allow the LLM 300 to weigh the importance of different words or tokens within the same input sequence (self-attention in the encoder 320) and between the input and output sequences (self-attention in the decoder 340), respectively.

In addition, the decoder 340 also includes an inter-attention or encoder-decoder attention neural network 330, which receives input from the output of the encoder 320. The encoder-decoder attention neural network 330 allows the decoder 340 to focus on relevant parts of the input sequence (output of the encoder 320) while generating the output sequence. As described below, the output of the encoder 320 is a continuous representation or embedding of the input sequence. By feeding the output of the encoder 320 to the encoder-decoder attention neural network 330, the contextual information and relationships captured in the input sequence (by the encoder 320) can be carried to the decoder 340. Such connection enables the decoder 340 to access to the entire input sequence, rather than just the last hidden state. Because the decoder 340 can attend to all words in the input sequence, the input information can be aligned with the generation of output to improve contextual accuracy of the generated text output.

In some examples, one or more of the attention neural networks (e.g., 306, 326, 330) can be configured to implement a single head attention mechanism, by which the model can capture relationships between words in an input sequence by assigning attention weights to each word based on its relevance to a target word. The term “single head” indicates that there is only one set of attention weights or one mechanism for capturing relationships between words in the input sequence. In some examples, one or more of the attention neural networks (e.g., 306, 326, 330) can be configured to implement a multi-head attention mechanism, by which multiple sets of attention weights, or “heads,” in parallel to capture different aspects of the input sequence. Each head learns distinct relationships and dependencies within the input sequence. These multiple attention heads can enhance the model's ability to attend to various features and patterns, enabling it to understand complex, multi-faceted contexts, thereby leading to more accurate and contextually relevant text generation. The outputs from multiple heads can be concatenated or linearly combined to produce a final attention output.

As depicted in FIG. 3, both the encoder 320 and the decoder 340 can include one or more addition and normalization layers (e.g., the layers 308 and 312 in the encoder 320, the layers 328, 332, and 336 in the decoder 340). The addition layer, also known as a residual connection, can add the output of another layer (e.g., an attention neural network or a feedforward network) to its input. After the addition operation, a normalization operation can be performed by a corresponding normalization layer, which normalizes the features (e.g., making the features to have zero mean and unit variance), This can help in stabilizing the learning process and reducing training time.

A linear layer 342 at the output end of the decoder 340 can transform the output embeddings into the original input space. Specifically, the output embeddings produced by the decoder 340 are forwarded to the linear layer 342, which can transform the high-dimensional output embeddings into a space where each dimension corresponds to a word in the vocabulary of the LLM 300.

The output of the linear layer 342 can be fed to a softmax layer 344, which is configured to implement a softmax function, also known as softargmax or normalized exponential function, which is a generalization of the logistic function that compresses values into a given range. Specifically, the softmax layer 344 takes the output from the linear layer 342 (also known as logits) and transforms them into probabilities. These probabilities sum up to 1, and each probability corresponds to the likelihood of a particular word being the next word in the sequence. Typically, the word with the highest probability can be selected as the next word in the generated text output.

Still referring to FIG. 3, the general operation process for the LLM 300 to generate a reply or text output in response to a received prompt input is described below.

First, the input text is tokenized, e.g., by the input embedding unit 302, into a sequence of tokens, each representing a word or part of a word. Each token is then mapped to a fixed-length vector or input embedding. Then, positional encoding 304 is added to the input embeddings to retain information regarding the order of words in the input text.

Next, the input embeddings are processed by the self-attention neural network 306 of the encoder 320 to generate a set of hidden states. As described above, multi-head attention mechanism can be used to focus on different parts of the input sequence. The output from the self-attention neural network 306 is added to its input (residual connection) and then normalized at the addition and normalization layer 308.

Then, the feedforward neural network 310 is applied to each token independently. The feedforward neural network 310 includes fully connected layers with non-linear activation functions, allowing the model to capture complex interactions between tokens. The output from the feedforward neural network 310 is added its input (residual connection) and then normalized at the addition and normalization layer 312.

The decoder 340 uses the hidden states from the encoder 320 and its own previous output sequence to generate the next token in an autoregressive manner so that the sequential output is generated by attending to the previously generated tokens. Specifically, the output of the encoder 320 (input embeddings processed by the encoder 320) are fed to the encoder-decoder attention neural network 330 of the decoder 340, which allows the decoder 340 to attend to all words in the input sequence. As described above, the encoder-decoder attention neural network 330 can implement a multi-head attention mechanism, e.g., computing a weighted sum of all the encoded input vectors, with the most relevant vectors being attributed the highest weights.

The previous output sequence of the decoder 340 is first tokenized by the output embedding unit 322 to generate an output embedding for each token in the output sequence. Similarly, positional embedding 324 is added to the output embedding to retain information regarding the order of words in the output sequence.

The output embeddings are processed by the self-attention neural network 326 of the decoder 340 to generate a set of hidden states. The self-attention mechanism allows each token in the text output to attend to all tokens in the input sequence as well as all previous tokens in the output sequence. The output from the self-attention neural network 326 is added to its input (residual connection) and then normalized at the addition and normalization layer 328.

The encoder-decoder attention neural network 330 receives the output embeddings processed through the self-attention neural network 326 and the addition and normalization layer 328. Additionally, the encoder-decoder attention neural network 330 also receives the output from the addition and normalization layer 312 which represents input embeddings processed by the encoder 320. By considering both processed input embeddings and output embeddings, the output of the encoder-decoder attention neural network 330 represents an output embedding which takes into account both the input sequence and the previously generated outputs. As a result, the decoder 340 can generate the output sequence that is contextually aligned with the input sequence.

The output from the encoder-decoder attention neural network 330 is added to part of its input (residual connection), i.e., the output from the addition and normalization layer 328, and then normalized at the addition and normalization layer 332. The normalized output from the addition and normalization layer 332 is then passed through the feedforward neural network 334. The output of the feedforward neural network 334 is then added to its input (residual connection) and then normalized at the addition and normalization layer 336.

The processed output embeddings output by the decoder 340 are passed through the linear layer 342, which maps the high-dimensional output embeddings back to the size of the vocabulary, that is, it transforms the output embeddings into a space where each dimension corresponds to a word in the vocabulary. The softmax layer 344 then converts output of the linear layer 342 into probabilities, each of which corresponds to the likelihood of a particular word being the next word in the sequence. Finally, the LLM 300 samples an output token from the probability distribution generated by the softmax layer 344 (e.g., selecting the token with the highest probability), and this token is added to the sequence of generated tokens for the text output.

The steps described above are repeated for each new token until an end-of-sequence token is generated or a maximum length is reached. Additionally, if the encoder 320 and/or decoder 340 have multiple stacked layers, the steps performed by the encoder 320 and decoder 340 are repeated across each layer in the encoder 320 and the decoder 340 for generation of each new token.

### Example Process for Creating Vector Database

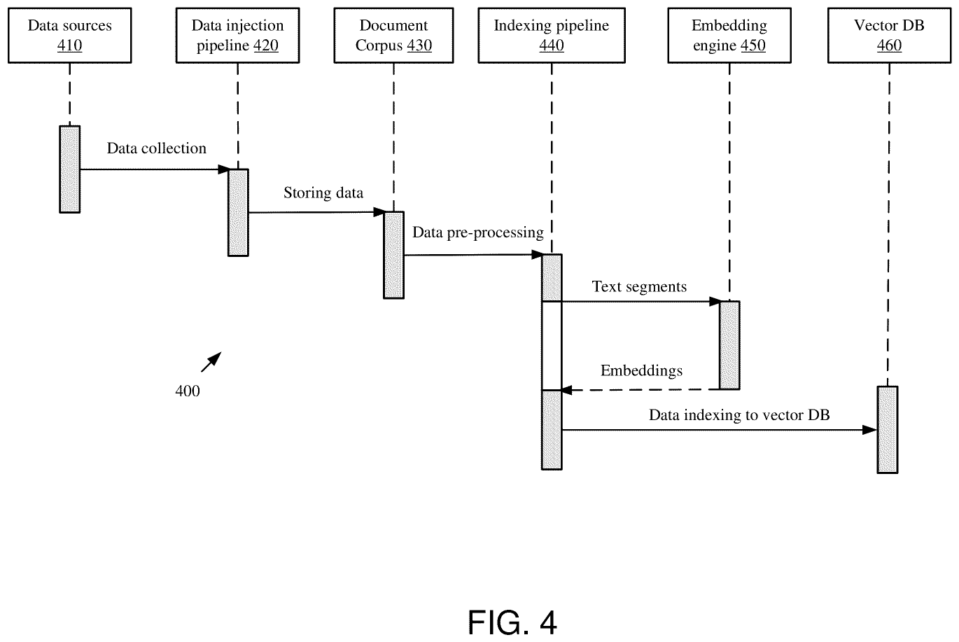

FIG. 4 is a sequence diagram illustrating an example process 400 for creating a vector database, which can be performed during the design phase.

The process 400 begins with a data injection pipeline 420 (similar to the data injection pipeline 136) collecting relevant documents (e.g., Value Advisories, sales records, etc.) from various data sources 410 (similar to data sources 140). The data injection pipeline 420 can utilize different application programming interfaces (APIs) to access these diverse data sources 410, each of which may have distinct access requirements, such as authentication protocols or rate limits, and may provide documents in various file types (e.g., PDFs, spreadsheets, or structured data). The collected documents are then stored in a central repository or document corpus 430 (similar to the document corpus 134), which functions as a data lake that aggregates and normalizes data from the diverse data sources 410.

An indexing pipeline 440 (similar to the indexing pipeline 132) can pre-process documents stored in the document corpus 430. For example, the indexing pipeline 440 can perform data cleaning tasks, such as removing duplicates, eliminating special characters or formatting inconsistencies, and standardizing the document structure. The remaining text in the documents can then be organized into respective text fields based on categories such as headings, body content, and metadata. After data cleaning, the indexing pipeline 440 can divide the documents into smaller text segments, a process known as chunking. Chunking can be performed with either overlapping or non-overlapping segments. Overlapping segments ensure that contextual information flows across boundaries, while non-overlapping segments offer a more discrete division that may be more efficient for certain use cases. Different segmentation techniques can also be applied based on the file type. For text-heavy documents like PDFs or WORD files, segmentation might be based on paragraph or sentence boundaries, whereas for structured data files like spreadsheets, segmentation can be based on logical data groupings such as rows, columns, or cells.

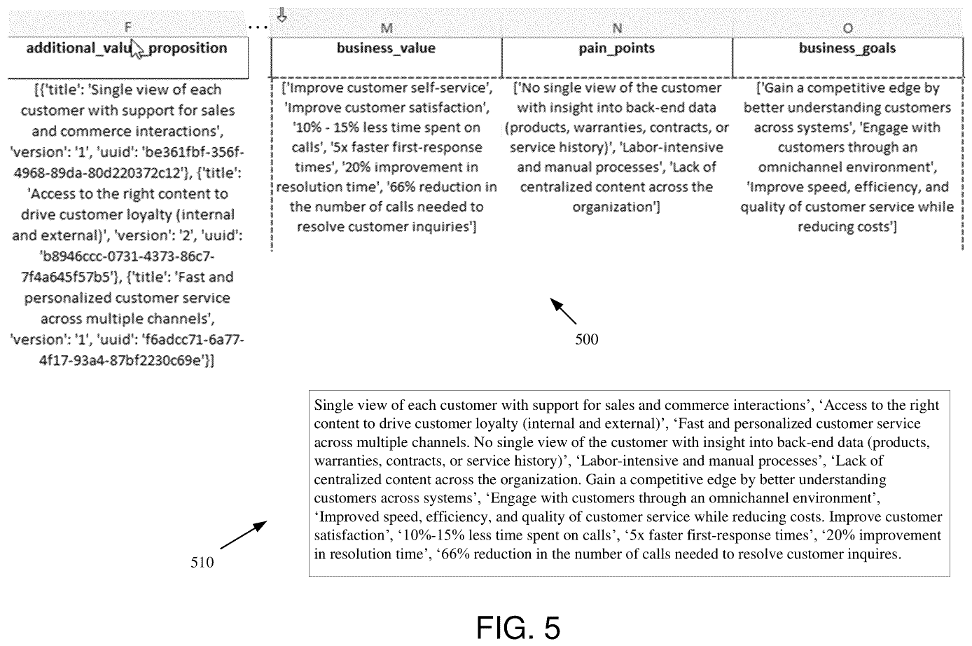

As an example, FIG. 5 depicts some text fields 500 extracted from an SAP full sales Article Record which includes many sections with various headings such as “additional value proposition,” “business value,” “pain points,” “business goals,” among others. Text descriptions under each section and corresponding metadata (e.g., unique identifier and version number of the corresponding document, etc.) are extracted under a text field, where the field name is generated based on the section heading. After data cleaning, the document can be segmented, and an example text segment 510 including some of the extracted text fields 500 is shown in FIG. 5.

The indexing pipeline 440 can send the text segments to an embedding engine 450 (similar to the embedding engine 122), which can generate respective vector embeddings (e.g., using the embedding model 112). These vector embeddings capture the semantic and syntactic relationships within each text segment, translating them into multi-dimensional representations that can be efficiently processed and compared.

The embedding engine 450 returns the generated vector embeddings to the indexing pipeline 440, which can then index these vector embeddings in a vector database 460 (similar to the vector database 130). This indexing process can involve associating each vector embedding with its corresponding text segment, document metadata, and any other relevant identifiers, enabling efficient search and retrieval.

### Example Runtime Product Recommendation

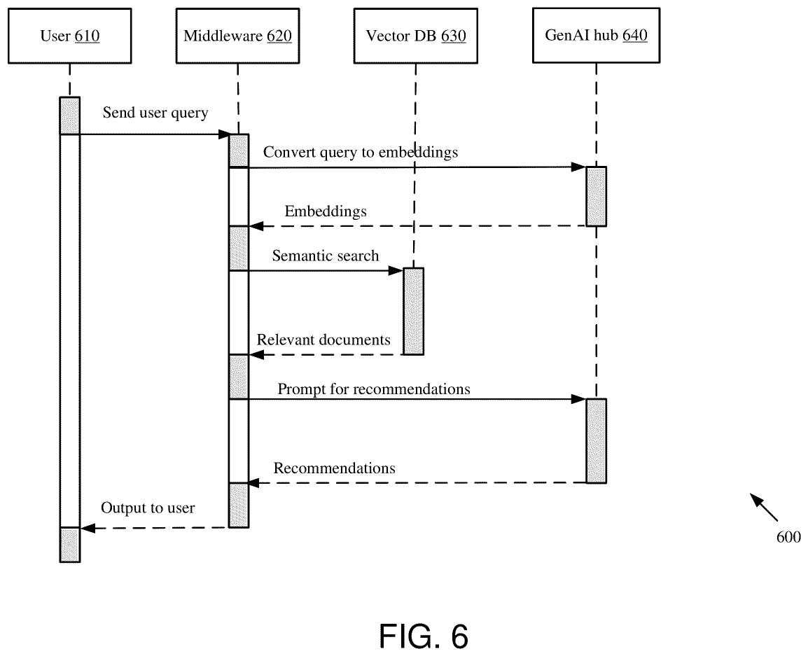

FIG. 6 is a sequence diagram illustrating an example process 600 for product recommendation, which can be performed during the runtime.

In this example, a user 610 sends a user query to a middleware 620, a software application implementing the intelligent recommendation engine's functionalities (e.g., the intelligent recommendation engine 120). The user query describes challenges or issues the user is facing. Upon receiving the user query, the middleware 620 can convert it into an input vector embedding. This transformation can be performed by using an embedding model (e.g., the embedding model 112) housed within a generative AI hub 640 (e.g., the generative AI hub 110).

Once the input vector embedding is generated, the middleware 620 can initiate a semantic search of a vector database 630 (e.g., similar to the vector database 130 or 460). The search can identify target documents containing relevant text segments whose vector embeddings, previously indexed in the vector database 630, exhibit high similarity to the input vector embedding. For example, the middleware 620 can rank the vector embeddings based on their similarity scores and select the top N text segments that most semantically align with the user query.

After identifying target documents containing relevant text segments, the middleware 620 can construct a prompt by populating a predefined prompt template with these text segments and their associated similarity scores. The composed prompt can then be sent to a generative AI model (e.g., the generative AI model 114) on the generative AI hub 640, instructing the generative AI model to generate a ranked list of documents that contain potential solutions to the user's challenges.

After receiving the response produced by the generative AI model, the middleware 620 can deliver the ranked recommendations to the user 610. The recommendations provide actionable insights or solutions tailored to the specific challenges described in the user query. In some examples, the middleware 620 can also retrieve reference sources directly from target documents that were identified during the semantic search process. These reference sources, such as sections or passages corresponding to the relevant text segments, can be retrieved based on their relevance to the recommended solutions. The middleware 620 can then present these reference sources to the user, allowing them to review the original context of the recommendations, thereby enabling the user to gain a deeper understanding of the proposed solutions and facilitating more informed decision-making.

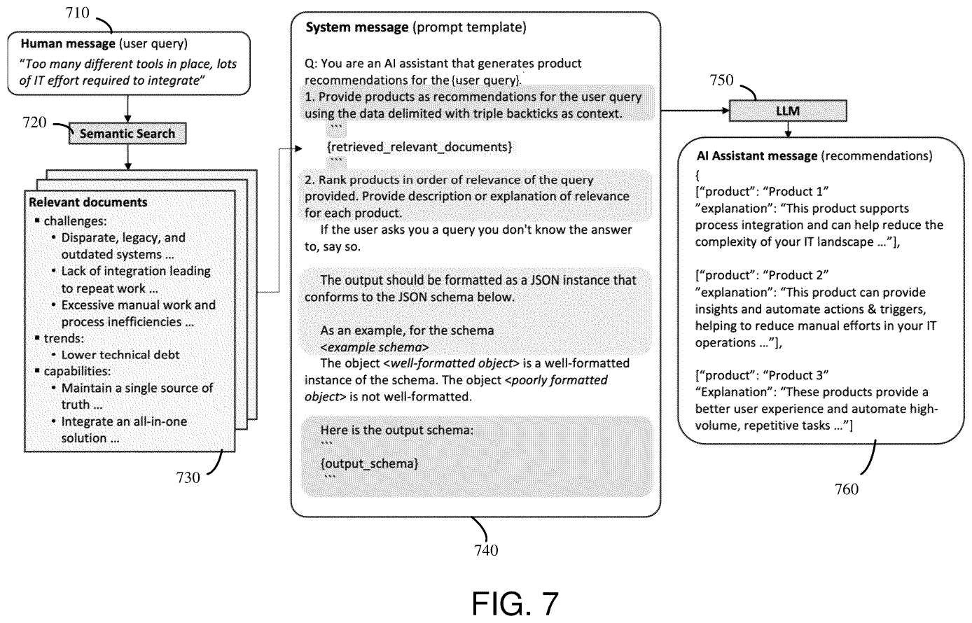

FIG. 7 further schematically illustrates the runtime product recommendation process. In this example, a user entered a user query 710 describing some key pain points (e.g., “Too many different tools in place, lots of IT effort required to integrate.”). A semantic search 720 is performed after first converting the user query 710 into an input vector embedding, and then performing similarity analysis against vector embeddings indexed in a vector database. The outcome of the semantic search 720 includes target documents 730 that contain text segments deemed most semantically relevant to the user query 710. These text segments, along with their corresponding similarity scores, are incorporated in a prompt template 740.

The prompt template 740 specifies the role and task of the generative AI model, such as the LLM 750. Specifically, the prompt template 740 instructs the LLM 750 to “Rank products in order of relevance of the query provided. Provide description or explanation of relevance for each product.” The prompt template 740 includes a plurality of placeholders (enclosed in curly brackets) which can respectively receive the user query, the retrieved relevant text segments, an output schema specifying the format of the generated recommendations (e.g., as JSON objects), etc. After receiving the prompt, the LLM 750 can generate a response 760 containing a ranked list of recommendations organized according to the specified output format.

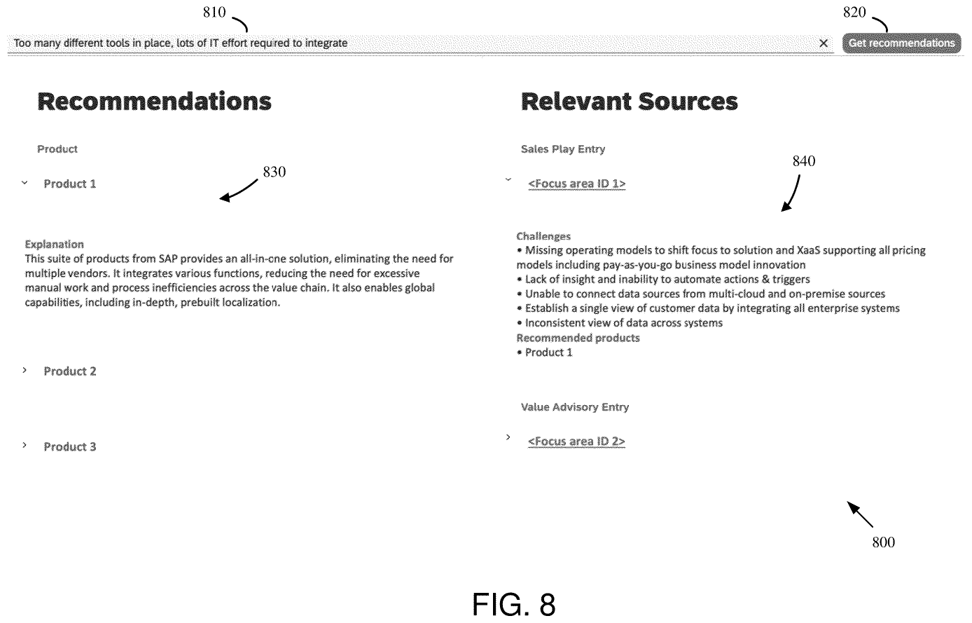

FIG. 8 depicts an example user interface 800 for intelligent product recommendation. As shown, the user interface 800 includes a text field 810 for a user to enter a natural language user query. After confirming the input, e.g., by clicking a button 820, the intelligent product recommendation engine can automatically prompt a generative AI model to generate an output including a ranked list of product recommendations 830. The recommendations 830 can include brief summaries for each recommended product, explaining how and why each product can address the challenges or issues faced by the user. Additionally, the intelligent product recommendation engine can also retrieve and display reference sources 840 corresponding to the recommendations 830, providing the user with further context and supporting information to help the user make more informed decisions.

### Example Handling of Cold Start Scenarios

The intelligent product recommendation system disclosed herein can operate in conjunction with another AI module to handle code start scenarios, where a new customer without any prior purchasing data wants product recommendations. For example, another AI module (e.g., intelligent customer news analysis, or iCNA, provided by SAP SE of Walldorf, Germany) can be used to analyze external data sources, such as financial news, to infer potential challenges and needs of new customers. Specifically, this AI module can process the external data to generate a profile of the new customer's challenges and requirements. These inferred challenges can then be used to formulate a user query describing customer challenges. As described above, the intelligent product recommendation system can utilize this formulated user query to perform a semantic search against the vector database to retrieve relevant text segments that match the inferred challenges. These text segments are then incorporated into a prompt to provide contextual information for the generative AI model, enabling it to generate accurate and relevant product recommendations tailored to the new customer's needs.

### Example Advantages

The technologies described herein offer several technical advantages.

By leveraging generative AI, the disclosed intelligent product recommendation system can automate what was traditionally a manual and time-consuming market research process. This automation not only makes the process more efficient by reducing the effort required from users but also minimizes the potential for human errors. The disclosed system can generate actionable recommendations based on relevant documents (including previous customer sales records) and current customer queries. Moreover, the disclosed system can provide detailed explanations for each recommended product, illustrate how and why these products meet the specific challenges encountered by the user. This added transparency fosters trust, as users can clearly see the rationale behind each product suggestion.

The disclosed technologies also offer significant technical improvements over traditional rule-based NLP systems by incorporating advanced semantic analysis. This enhancement allows the system to effectively handle diverse language patterns and various writing styles, making it more adaptable to the nuances of human language. Additionally, the system can process data from a wide range of sources with different file formats, thereby increasing its versatility and data integration capabilities. Furthermore, these improvements enhance scalability, enabling the system to efficiently accommodate growing datasets and evolving user demands.

Further, the disclosed technologies address the challenges of biased models in conventional NLP systems, particularly when faced with imbalanced or insufficient training data, as is often the case with niche B2B products that have limited purchase records. By leveraging semantic analysis, the intelligent product recommendation system can better capture the underlying meaning of user queries and product descriptions, allowing it to generate more accurate recommendations even when explicit patterns in the data are sparse.

### Example Computing Systems

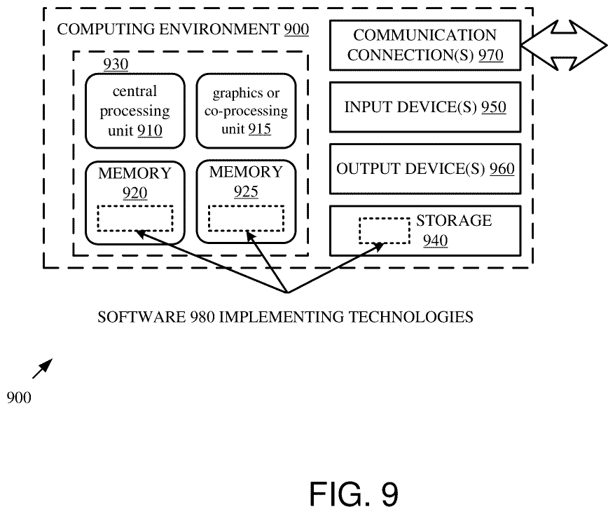

FIG. 9 depicts an example of a suitable computing system 900 in which the described innovations can be implemented. The computing system 900 is not intended to suggest any limitation as to scope of use or functionality of the present disclosure, as the innovations can be implemented in diverse computing systems.

With reference to FIG. 9, the computing system 900 includes one or more processing units 910, 915 and memory 920, 925. In FIG. 9, this basic configuration 930 is included within a dashed line. The processing units 910, 915 can execute computer-executable instructions, such as for implementing the features described in the examples herein (e.g., the method 200). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 9 shows a central processing unit 910 as well as a graphics processing unit or co-processing unit 915. The tangible memory 920, 925 can be volatile memory (e.g., registers, cache, RAM), non-volatile memory (e.g., ROM, EEPROM, flash memory, etc.), or some combination of the two, accessible by the processing unit(s) 910, 915. The memory 920, 925 can store software 980 implementing one or more innovations described herein, in the form of computer-executable instructions suitable for execution by the processing unit(s) 910, 915.

A computing system 900 can have additional features. For example, the computing system 900 can include storage 940, one or more input devices 950, one or more output devices 960, and one or more communication connections 970, including input devices, output devices, and communication connections for interacting with a user. An interconnection mechanism (not shown) such as a bus, controller, or network can interconnect the components of the computing system 900. Typically, operating system software (not shown) can provide an operating environment for other software executing in the computing system 900, and coordinate activities of the components of the computing system 900.

The tangible storage 940 can be removable or non-removable, and includes magnetic disks, magnetic tapes or cassettes, CD-ROMs, DVDs, or any other medium which can be used to store information in a non-transitory way and which can be accessed within the computing system 900. The storage 940 can store instructions for the software implementing one or more innovations described herein.

The input device(s) 950 can be an input device such as a keyboard, mouse, pen, or trackball, a voice input device, a scanning device, touch device (e.g., touchpad, display, or the like) or another device that provides input to the computing system 900. The output device(s) 960 can be a display, printer, speaker, CD-writer, or another device that provides output from the computing system 900.

The communication connection(s) 970 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

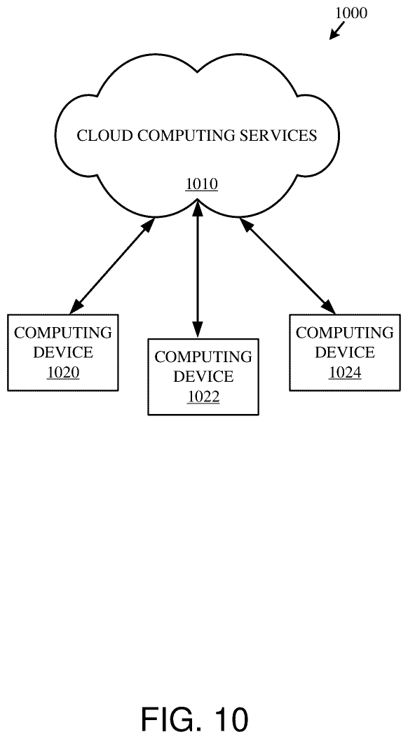

FIG. 10 depicts an example cloud computing environment 1000 in which the described technologies can be implemented, including, e.g., the system 100 and other systems herein. The cloud computing environment 1000 can include cloud computing services 1010. The cloud computing services 1010 can comprise various types of cloud computing resources, such as computer servers, data storage repositories, networking resources, etc. The cloud computing services 1010 can be centrally located (e.g., provided by a data center of a business or organization) or distributed (e.g., provided by various computing resources located at different locations, such as different data centers and/or located in different cities or countries).

The cloud computing services 1010 can be utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices. For example, the computing devices (e.g., 1020, 1022, and 1024) can utilize the cloud computing services 1010 to perform computing operations (e.g., data processing, data storage, and the like).

In practice, cloud-based, on-premises-based, or hybrid scenarios can be supported.

### Example Implementations

In any of the examples herein, a software application (or “application”) can take the form of a single application or a suite of a plurality of applications, whether offered as a service (SaaS), in the cloud, on premises, on a desktop, mobile device, wearable, or the like.

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

Although specific prompt templates are described above, it should be understood that these prompt templates are merely examples for illustration purposes, and different prompt templates can be used based on the principles described herein.

In any of the examples described herein, an operation performed in runtime or real-time means that the operation can be completed with negligible processing latency (e.g., the operation can be completed within 1 second, etc.).

### Example Clauses

Any of the following example clauses can be implemented.

Clause 1. A computing system comprising: memory; one or more hardware processors coupled to the memory; and one or more computer readable storage media storing instructions that, when loaded into the memory, cause the one or more hardware processors to perform operations comprising: receiving, from a user interface, a query in natural language describing challenges encountered by a user; obtaining, in runtime, one or more text segments that are semantically related to the query; composing, in runtime, a prompt using a prompt template, wherein the prompt template includes a placeholder for receiving the one or more text segments; prompting, in runtime, a generative artificial intelligence (AI) model using the prompt to determine a ranked list of documents containing solutions to address the challenges; and presenting a response generated by the generative AI model on the user interface.

Clause 2. The computing system of clause 1, wherein the operation of obtaining one or more text segments semantically related to the query comprises converting the query into an input vector embedding.

Clause 3. The computing system of clause 2, wherein the operation of obtaining one or more text segments semantically related to the query further comprises measuring similarities between the input vector embedding and a plurality of vector embeddings stored in a vector database.

Clause 4. The computing system of clause 3, wherein the operation of obtaining one or more text segments semantically related to the query further comprises ranking the similarities and identifying top N vector embeddings that are associated with highest similarities, wherein N is a predefined positive integer.

Clause 5. The computing system of any one of clauses 3-4, wherein the operations further comprise creating the vector database based on a set of documents collected from a plurality of data sources.

Clause 6. The computing system of clause 5, wherein the operation of creating the vector database comprises cleaning the set of documents, wherein the cleaning removes duplicates and special characters from the set of documents, and organizes remaining text in the set of documents in respective text fields.

Clause 7. The computing system of any one of clauses 5-6, wherein the operation of creating the vector data comprises dividing the set of documents into a plurality of text segments.

Clause 8. The computing system of clause 7, wherein the operation of creating the vector data further comprises converting the plurality of text segments into respective vector embeddings, and indexing the plurality of text segments and the respective vector embeddings in the vector database.

Clause 9. The computing system of any one of clauses 5-8, wherein the operations further comprise periodically updating the vector database, comprising scanning the plurality of data sources to detect whether there is an update to the set of documents.

Clause 10. The computing system of any one of clauses 1-9, wherein the operations further comprise retrieving reference sources based on the response generated by the generative AI model, and presenting the reference sources on the user interface.

Clause 11. A computer-implemented method comprising: receiving, from a user interface, a query in natural language describing challenges encountered by a user; obtaining, in runtime, one or more text segments that are semantically related to the query; composing, in runtime, a prompt using a prompt template, wherein the prompt template includes a placeholder for receiving the one or more text segments; prompting, in runtime, a generative artificial intelligence (AI) model using the prompt to determine a ranked list of documents containing solutions to address the challenges; and presenting a response generated by the generative AI model on the user interface.

Clause 12. The computer-implemented method of clause 11, wherein obtaining one or more text segments semantically related to the query comprises converting the query into an input vector embedding.

Clause 13. The computer-implemented method of clause 12, wherein obtaining one or more text segments semantically related to the query further comprises measuring similarities between the input vector embedding and a plurality of vector embeddings stored in a vector database.

Clause 14. The computer-implemented method of clause 13, wherein obtaining one or more text segments semantically related to the query further comprises ranking the similarities and identifying top N vector embeddings that are associated with highest similarities, wherein N is a predefined positive integer.

Clause 15. The computer-implemented method of any one of clauses 13-14, further comprising creating the vector database based on a set of documents collected from a plurality of data sources.

Clause 16. The computer-implemented method of clause 15, wherein creating the vector database comprises cleaning the set of documents, wherein the cleaning removes duplicates and special characters from the set of documents, and organizes remaining text in the set of documents in respective text fields.

Clause 17. The computer-implemented method of any one of clauses 15-16, wherein creating the vector data comprises dividing the set of documents into a plurality of text segments, converting the plurality of text segments into respective vector embeddings, and indexing the plurality of text segments and the respective vector embeddings in the vector database.

Clause 18. The computer-implemented method of any one of clauses 15-17, further comprising periodically updating the vector database, comprising scanning the plurality of data sources to detect whether there is an update to the set of documents.

Clause 19. The computer-implemented method of any one of clauses 11-18, further comprising retrieving reference sources based on the response generated by the generative AI model, and presenting the reference sources on the user interface.

Clause 20. One or more non-transitory computer-readable media having encoded thereon computer-executable instructions causing one or more processors to perform a method, the method comprising: receiving, from a user interface, a query in natural language describing challenges encountered by a user; obtaining, in runtime, one or more text segments that are semantically related to the query; composing, in runtime, a prompt using a prompt template, wherein the prompt template includes a placeholder for receiving the one or more text segments; prompting, in runtime, a generative artificial intelligence (AI) model using the prompt to determine a ranked list of documents containing solutions to address the challenges; and presenting a response generated by the generative AI model on the user interface.

The technologies from any clauses can be combined with the technologies described in any one or more of the other clauses.

### Example Alternatives

In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
memory;
one or more hardware processors coupled to the memory; and
one or more computer readable storage media storing instructions that, when loaded into the memory, cause the one or more hardware processors to perform operations comprising:
receiving, from a user interface, a query in natural language describing challenges encountered by a user;
obtaining, in runtime, one or more text segments that are semantically related to the query;
composing, in runtime, a prompt using a prompt template, wherein the prompt template includes a placeholder for receiving the one or more text segments;
prompting, in runtime, a generative artificial intelligence (AI) model using the prompt to determine a ranked list of documents containing solutions to address the challenges; and
presenting a response generated by the generative AI model on the user interface.

2. The computing system of claim 1, wherein the operation of obtaining one or more text segments semantically related to the query comprises converting the query into an input vector embedding.

3. The computing system of claim 2, wherein the operation of obtaining one or more text segments semantically related to the query further comprises measuring similarities between the input vector embedding and a plurality of vector embeddings stored in a vector database.

4. The computing system of claim 3, wherein the operation of obtaining one or more text segments semantically related to the query further comprises ranking the similarities and identifying top N vector embeddings that are associated with highest similarities, wherein N is a predefined positive integer.

5. The computing system of claim 3, wherein the operations further comprise creating the vector database based on a set of documents collected from a plurality of data sources.

6. The computing system of claim 5, wherein the operation of creating the vector database comprises cleaning the set of documents, wherein the cleaning removes duplicates and special characters from the set of documents, and organizes remaining text in the set of documents in respective text fields.

7. The computing system of claim 5, wherein the operation of creating the vector data comprises dividing the set of documents into a plurality of text segments.

8. The computing system of claim 7, wherein the operation of creating the vector data further comprises converting the plurality of text segments into respective vector embeddings, and indexing the plurality of text segments and the respective vector embeddings in the vector database.

9. The computing system of claim 5, wherein the operations further comprise periodically updating the vector database, comprising scanning the plurality of data sources to detect whether there is an update to the set of documents.

10. The computing system of claim 1, wherein the operations further comprise retrieving reference sources based on the response generated by the generative AI model, and presenting the reference sources on the user interface.

11. A computer-implemented method comprising:
receiving, from a user interface, a query in natural language describing challenges encountered by a user;
obtaining, in runtime, one or more text segments that are semantically related to the query;
composing, in runtime, a prompt using a prompt template, wherein the prompt template includes a placeholder for receiving the one or more text segments;
prompting, in runtime, a generative artificial intelligence (AI) model using the prompt to determine a ranked list of documents containing solutions to address the challenges; and
presenting a response generated by the generative AI model on the user interface.

12. The computer-implemented method of claim 11, wherein obtaining one or more text segments semantically related to the query comprises converting the query into an input vector embedding.

13. The computer-implemented method of claim 12, wherein obtaining one or more text segments semantically related to the query further comprises measuring similarities between the input vector embedding and a plurality of vector embeddings stored in a vector database.

14. The computer-implemented method of claim 13, wherein obtaining one or more text segments semantically related to the query further comprises ranking the similarities and identifying top N vector embeddings that are associated with highest similarities, wherein N is a predefined positive integer.

15. The computer-implemented method of claim 13, further comprising creating the vector database based on a set of documents collected from a plurality of data sources.

16. The computer-implemented method of claim 15, wherein creating the vector database comprises cleaning the set of documents, wherein the cleaning removes duplicates and special characters from the set of documents, and organizes remaining text in the set of documents in respective text fields.

17. The computer-implemented method of claim 15, wherein creating the vector data comprises dividing the set of documents into a plurality of text segments, converting the plurality of text segments into respective vector embeddings, and indexing the plurality of text segments and the respective vector embeddings in the vector database.

18. The computer-implemented method of claim 15, further comprising periodically updating the vector database, comprising scanning the plurality of data sources to detect whether there is an update to the set of documents.

19. The computer-implemented method of claim 11, further comprising retrieving reference sources based on the response generated by the generative AI model, and presenting the reference sources on the user interface.

20. One or more non-transitory computer-readable media having encoded thereon computer-executable instructions causing one or more processors to perform a method, the method comprising:
receiving, from a user interface, a query in natural language describing challenges encountered by a user;
obtaining, in runtime, one or more text segments that are semantically related to the query;
composing, in runtime, a prompt using a prompt template, wherein the prompt template includes a placeholder for receiving the one or more text segments;
prompting, in runtime, a generative artificial intelligence (AI) model using the prompt to determine a ranked list of documents containing solutions to address the challenges; and
presenting a response generated by the generative AI model on the user interface.
